(19) United States
(12) Patent Application Publication
(10) Pub. No.: US 2026/0299728 A1
(43) Pub. Date: Oct. 1, 2026

(54) DISPLAY DEVICE AND ELECTRONIC DEVICE INCLUDING THE SAME

(71) Applicant: Samsung Display Co., Ltd., Yongin-Si (KR)

(72) Inventor: Kyushik Shin, Yongin-si (KR)

(21) Appl. No.: 19/382,267

(22) Filed: Nov. 7, 2025

(30) Foreign Application Priority Data
Mar. 26, 2025 (KR) 10-2025-0038472

(51) Int. Cl. G06F 3/041

(52) U.S. Cl. CPC G06F 3/04182

(57) ABSTRACT

An electronic device includes a first display module displaying an image based on first input image data in response to a display enable signal, a second display module displaying an image based on second input image data and a controller outputting the display enable signal. The first display module includes a display panel displaying the image based on a data signal, a touch panel performing a touch sensing operation, a driving controller outputting the data signal based on the first input image data in response to the display enable signal and a touch driver configured to drive the touch panel in response to a touch enable signal. The controller outputs the display enable signal based on a connection between the controller and the second display module. The driving controller outputs the touch enable signal in response to the display enable signal.

### CROSS-REFERENCE TO RELATED APPLICATIONS

This application claims priority, under 35 USC § 119, to Korean Patent Application No. 10-2025-0038472 filed on Mar. 26, 2025, the content of which is herein incorporated by reference in its entirety.

### BACKGROUND

### 1. Field

Embodiments of the present inventive concept relate to a display device and an electronic device including the same. More particularly, embodiments of the present inventive concept relate to a display device in which a display quality and a touch quality are improved and an electronic device including the same.

### 2. Description of Related Art

Generally, a display device includes a display panel and a display panel driver. The display panel includes a plurality of gate lines, a plurality of data lines, a plurality of emission lines and a plurality of pixels. The display panel driver includes a gate driver providing a gate signal to the gate lines, a data driver providing a data voltage to the data lines, an emission driver providing an emission signal to the emission lines and a driving controller controlling the gate driver, the data driver and the emission driver.

Generally, noise is generated when the driving of a display panel starts, and this noise adversely affects the reliability of touch sensing operation.

### SUMMARY

Embodiments of the present inventive concept provide a display device in which a display quality and a touch quality are improved.

Embodiments of the present inventive concept provide an electronic device in which a display quality and a touch quality are improved.

According to embodiments, an electronic device may include a first display module configured to display an image based on first input image data in response to a display enable signal, a second display module configured to display an image based on second input image data and a controller configured to output the display enable signal, the first input image data and the second input image data. The first display module may include a display panel having pixels that display the image based on a data signal, a touch panel having touch sensors that perform a touch sensing operation, a driving controller configured to output the data signal based on the first input image data in response to the display enable signal and a touch driver configured to drive the touch panel in response to a touch enable signal. The controller may output the display enable signal based on a connection between the controller and the second display module. The driving controller may output the touch enable signal in response to the display enable signal.

In an embodiment, wherein a connection signal may have an active level in response to the second display module and the controller being connected, . The driving controller may be turned off in response to the connection signal having an active level. After the driving controller is turned off, the touch driver may be turned off.

In an embodiment, wherein the connection signal may have an active level and the controller may output the display enable signal having an inactive level in response to the second display module and the controller being connected. The driving controller may output the touch enable signal having an inactive level in response to the display enable signal having an inactive level. The driving controller may be turned off in response to the display enable signal having an inactive level. The touch driver may be turned off in response to the touch enable signal having an inactive level.

In an embodiment, a connection signal may have an inactive level in response to the second display module and the controller being disconnected. The driving controller may be turned on in response to the connection signal having an inactive level. After the driving controller is turned on, the touch driver may be turned on.

In an embodiment, the connection signal may have an inactive level and the controller may output the display enable signal having an active level in response to the second display module and the controller being disconnected. The driving controller may output the touch enable signal having an active level in response to the display enable signal having an active level. The driving controller may be turned on in response to the display enable signal having an active level. The touch driver may be turned on in response to the touch enable signal having an active level.

In an embodiment, a period in which the first display module is driven may include a first period, a second period, and a third period. In the first period, the touch enable signal may have an inactive level, and the display enable signal may have an inactive level. In the second period, the touch enable signal may have an inactive level, and the display enable signal may have an active level. In the third period, the touch enable signal may have an active level, and the display enable signal may have an active level.

In an embodiment, in the second period, the driving controller may be turned on, and the touch driver may maintain a turned off state.

In an embodiment, in the third period, the driving controller may maintain a turned on state, and the touch driver may be turned on.

In an embodiment, the first display module may further include a connection block which connects the driving controller and the touch driver. The connection block may output a converted touch enable signal in which the touch enable signal is delayed to the touch driver.

In an embodiment, an active voltage level of the converted touch enable signal may be different from an active voltage level of the touch enable signal.

In an embodiment, the active voltage level of the converted touch enable signal may be higher than the active voltage level of the touch enable signal.

In an embodiment, the connection block may include a first resistor including a first terminal receiving the touch enable signal and a second terminal connected to a first node, a first switching element including a control electrode connected to the first node, a first electrode connected to a second node and a second electrode receiving a ground voltage, a second resistor including a first terminal receiving a first voltage and a second terminal connected to the second node, a third resistor including a first terminal connected to the second node and a second terminal connected to a third node, a second switching element including a control electrode connected to the third node, a first electrode connected to a fourth node, and a second electrode receiving the ground voltage and a fourth resistor including a first terminal receiving a second voltage different from the first voltage and a second terminal connected to the fourth node. The fourth node may output the converted touch enable signal.

In an embodiment, the connection block may include a first switching element including a control electrode receiving a first voltage, a first electrode receiving the touch enable signal and a second electrode receiving the converted touch enable signal, a first resistor including a first terminal receiving the first voltage and a second terminal connected to the first electrode of the first switching element and a second resistor including a first terminal receiving a second voltage different from the first voltage and a second terminal connected to the second electrode of the first switching element.

According to embodiments, an electronic device may include a first display module configured to display an image based on first input image data in response to a display enable signal and a controller configured to output the display enable signal and the first input image data. The controller may control the first display module in response to a connection signal. The first display module may stop operating in response to the connection signal having an active level. In response to the connection signal changing from an active level to an inactive level, the first display module may start a touch sensing operation after the display panel driving is started.

In an embodiment, a period in which the first display module is driven may include a first period, a second period, and a third period. In the first period, an operation of the first display module may be stopped. In the second period, the display panel driving may be performed, and the touch sensing operation may maintain stopped state. In the third period, the display panel driving may be performed, and the touch sensing operation may be performed.

In an embodiment, the first display module may include a driving controller configured to control the display panel driving in response to the display enable signal and a touch driver configured to perform the touch sensing operation in response to a touch enable signal. The driving controller may output the touch enable signal in response to the display enable signal.

In an embodiment, the first display module may further include a connection block connecting the driving controller and the touch driver. The connection block may output a converted touch enable signal which delays the touch enable signal reaching the touch driver.

In an embodiment, an active voltage level of the converted touch enable signal may be different from an active voltage level of the touch enable signal.

According to embodiments, a display device may include a display panel configured to display an image based on a data signal, a touch panel configured to perform a touch sensing operation, a driving controller configured to output the data signal based on a first input image data in response to a display enable signal and a touch driver configured to drive the touch panel in response to a touch enable signal. The driving controller may receive the display enable signal based on a connection signal indicating a connection to a display module. The driving controller may output the touch enable signal in response to the display enable signal.

In an embodiment, the display device may include a connection block connecting the driving controller and the touch driver. The connection block may output a converted touch enable signal which delays the touch enable signal reaching the touch driver.

As described above, based on a connection status between an external display module and a controller, a driving controller included in an electronic device may output a touch enable signal to the touch driver. Since the driving controller may output the touch enable signal to the touch driver, the reliability of the touch sensing operation and the display panel driving may be improved compared to a case where the controller outputs the touch enable signal. For example, when the external display module is disconnected from the controller, the touch sensing operation may be performed after the display panel driving is initiated. When the display panel driving is initiated after the touch sensing operation is initiated, a reliability of the touch sensing operation may be deteriorated based on the initiation of the display panel driving. Since the touch sensing operation may be performed after the display panel driving is initiated, a reliability of the touch sensing operation may be improved. Accordingly, a display quality and a touch quality of the electronic device may be improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating an electronic device according to embodiments of the present inventive concept.

FIG. 2 is a block diagram illustrating an example of a first display module included in an electronic device of FIG. 1.

FIG. 3 is a block diagram illustrating an example of a first display module included in an electronic device of FIG. 1.

FIG. 4 is a cross-sectional view illustrating a display panel according to an embodiment.

FIG. 5 is a cross-sectional view illustrating a display panel according to an embodiment.

FIG. 6 is a block diagram illustrating an example of a second display module, a controller, a driving controller and a touch driver included in an electronic device of FIG. 1.

FIG. 7 is a timing diagram illustrating an example of a period in which a first display module of FIG. 2 is driven.

FIG. 8 is a block diagram illustrating an operation of an electronic device in a first period of FIG. 7.

FIG. 9 is a block diagram showing an operation of an electronic device in a second period of FIG. 7.

FIG. 10 is a block diagram illustrating an operation of an electronic device in a third period of FIG. 7.

FIG. 11 is a block diagram illustrating an operation of an electronic device in a fourth section of FIG. 7.

FIG. 12 is a block diagram illustrating an example of a first display module included in an electronic device of FIG. 1.

FIG. 13 is a circuit diagram illustrating an example of a connection block included in an electronic device of FIG. 12.

FIG. 14 is a circuit diagram illustrating an example of a connection block included in an electronic device of FIG. 12.

FIG. 15 is a block diagram illustrating an example of a second display module, a driving controller and a touch driver included in an electronic device of FIG. 1.

FIG. 16 is a block diagram illustrating an electronic device according to embodiments of the present inventive concept.

FIGS. 17 to 19 are schematic diagrams illustrating an electronic device according to embodiments.

### DETAILED DESCRIPTION OF THE INVENTIVE CONCEPT

Hereinafter, the present inventive concept will be explained in detail with reference to the accompanying drawings.

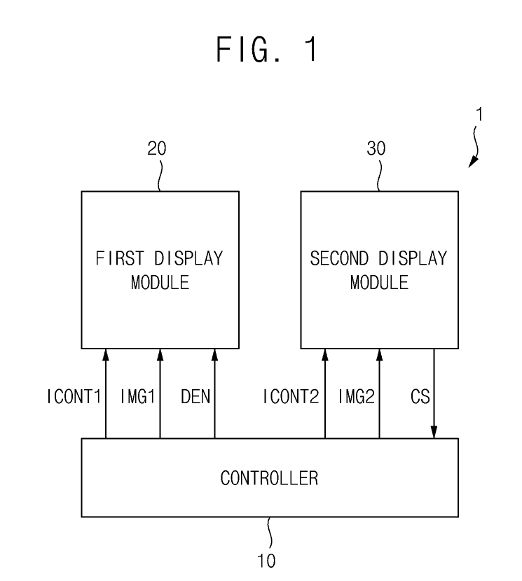

FIG. 1 is a block diagram illustrating an electronic device 1 according to embodiments of the present inventive concept.

Referring to FIG. 1, an electronic device 1 may include a controller 10, a first display module 20 and a second display module 30.

The controller 10 may output first input image data IMG1, a first input control signal ICONT1 and a display enable signal DEN to the first display module 20. The controller 10 may output second input image data IMG2 and a second input control signal ICONT2 to the second display module 30. The controller 10 may receive a connection signal CS from the second display module 30. The connection signal CS may indicate a connection between the second display module 30 and the controller 10.

When the controller 10 and the second display module 30 are connected, the connection signal CS may have an active level. When the connection signal CS has an active level, the controller 10 may output the display enable signal DEN having an inactive level to the first display module 20. When the display enable signal DEN has an inactive level, the first display module 20 may be turned off.

When the connection between the controller 10 and the second display module 30 are interrupted, the connection signal CS may have an inactive level. For example, when the controller 10 and the second display module 30 are not connected, the connection signal CS may have an inactive level. When the connection signal CS has an inactive level, the controller 10 may output the display enable signal DEN having an active level to the first display module 20. When the display enable signal DEN has an active level, the first display module 20 may be turned on.

The first display module 20 may receive the first input control signal ICONT1, the first input image data IMG1 and the display enable signal DEN. The first display module 20 may display an image corresponding to the first input image data IMG1 based on the first input control signal ICONT1, the first input image data IMG1 and the display enable signal DEN. The first display module 20 may be referred to as a display device.

The second display module 30 may receive the second input control signal ICONT2 and the second input image data IMG2. The second display module 30 may display an image corresponding to the second input image data IMG2 based on the second input control signal ICONT2 and the second input image data IMG2. For example, the second display module 30 may be an external display module. For example, the second display module 30 may be a display module additionally connected to the electronic device 1.

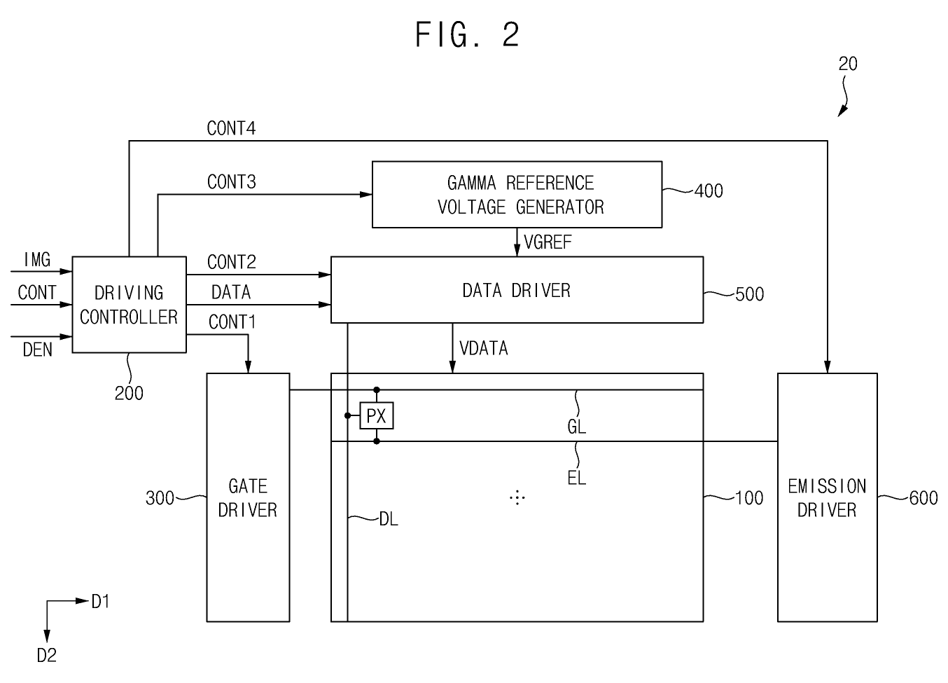

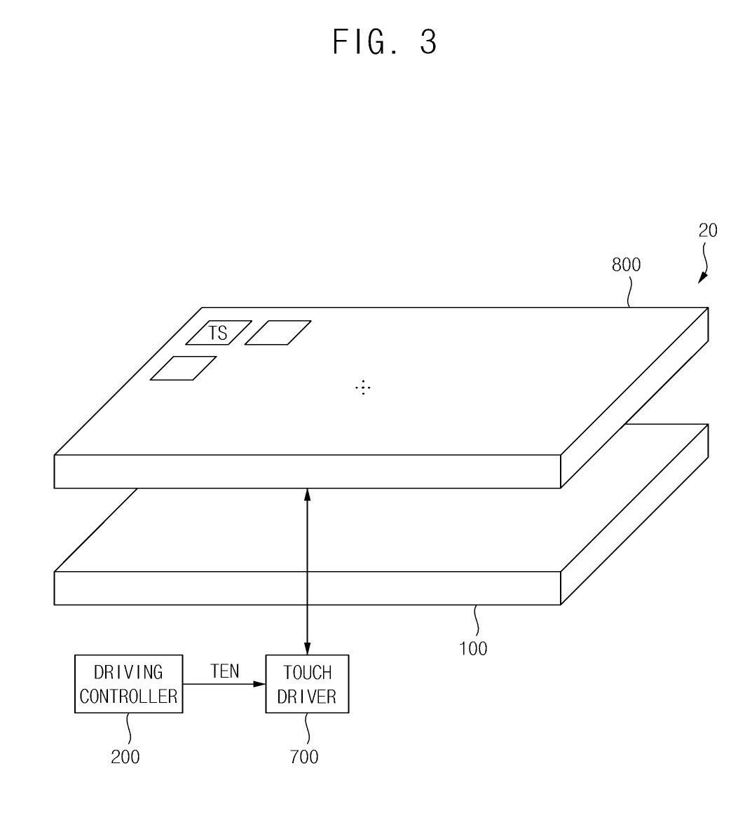

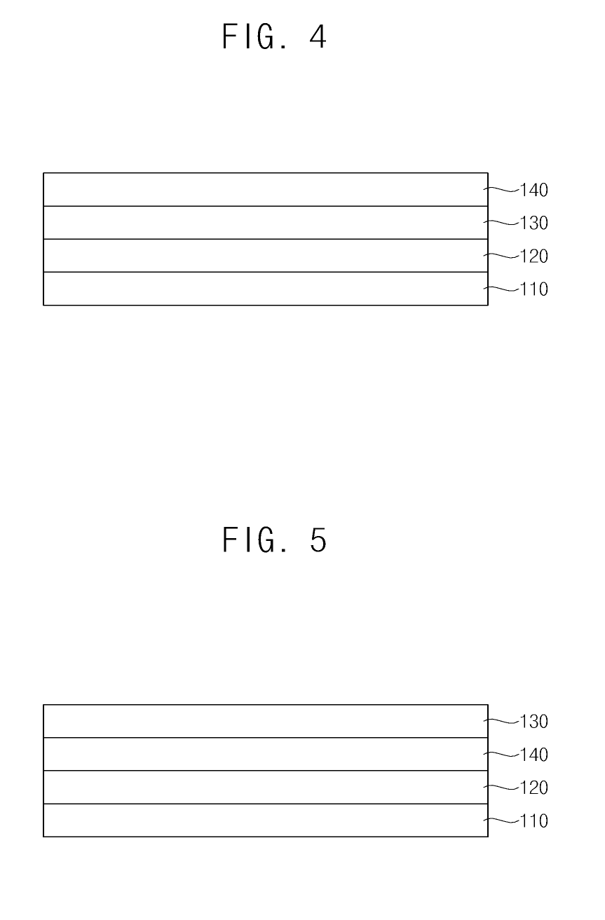

FIG. 2 is a block diagram illustrating an example of a first display module 20 included in an electronic device 1 of FIG. 1. FIG. 3 is a block diagram illustrating an example of a first display module 20 included in an electronic device 1 of FIG. 1. FIG. 4 is a cross-sectional view illustrating a display panel according to an embodiment. FIG. 5 is a cross-sectional view illustrating a display panel according to an embodiment.

Referring to FIGS. 1 and 5, the first display module 20 may include a display panel 100 and a display panel driver. In the present embodiment, the first display module 20 may further include a touch panel 800 disposed on the display panel 100 and a touch driver 700 which drives the touch panel 800.

The display panel driver may include a driving controller 200, a gate driver 300, a gamma reference voltage generator 400, a data driver 500 and an emission driver 600. An operation in which the display panel driver drive the display panel may be called as a display panel driving. In the present embodiment, the display panel driver may further include the touch driver 700.

The display panel 100 may include a display region on which an image is displayed and a peripheral region adjacent to the display region.

The display panel 100 may include a plurality of gate lines GL, plurality of emission lines EL, a plurality of data lines DL and a plurality of pixel circuit PX electrically connected to the gate lines GL, the emission lines EL and the data lines DL. The gate lines GL may extend in a first direction D1, the emission lines EL may extend in the first direction D1 and the data lines DL may extend in a second direction D2 crossing the first direction D1.

The driving controller 200 may receive input image data IMG and an input control signal CONT from an external apparatus. In an embodiment, for example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may control the display panel driving in response to the display enable signal DEN.

The driving controller 200 may generate a first control signal CONT1, a second control signal CONT2, a third control signal CONT3, a fourth control signal CONT4 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600.

The gate driver 300 may generate gate signals driving the gate lines GL in response to the first control signal CONT1 received from the driving controller 200. The gate driver 300 may output the gate signals to the gate lines GL.

In an embodiment, the gate driver 300 may be disposed in the peripheral region. In an embodiment, the gate driver 300 may be integrated in the peripheral region.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA.

In an embodiment, the gamma reference voltage generator 400 may be disposed in the driving controller 200, or in the data driver 500.

The data driver 500 may receive the second control signal CONT2 and the data signal DATA from the driving controller 200, and receive the gamma reference voltages VGREF from the gamma reference voltage generator 400. The data driver 500 may convert the data signal DATA into data voltages VDATA having an analog type using the gamma reference voltages VGREF. The data driver 500 may output the data voltages VDATA to the data lines DL.

In an embodiment, the data driver 500 may be disposed in the peripheral region. In an embodiment, the data driver 500 may be in the peripheral region.

The emission driver 600 may generate emission signal in response to the fourth control signal CONT4 received from the driving controller 200. The emission driver 600 may output the emission signal to the emission lines EL.

In an embodiment, the emission driver 600 may be disposed in the peripheral region. In an embodiment, the emission driver 600 may be integrated in the peripheral region.

Although FIG. 1 depicts an embodiment where the gate driver 300 is disposed on a first side of the display panel 100 and the emission driver 600 is disposed on a second side of the display panel 100 for convenience of illustration and description, the invention is not limited thereto. In another embodiment, the gate driver 300 and the emission driver 600 may be disposed on the first side of the display panel 100. In an embodiment, for example, the gate driver 300 and the emission driver 600 may be disposed on the peripheral region of the display panel 100 on a same side of the display region of the display panel 100. In an embodiment, for example, the gate driver 300 and the emission driver 600 may be formed integrally with each other as a single chip.

The touch penal 800 may include a touch sensor TS.

In FIG. 3, the touch panel 600 may be disposed outside of the display panel 100. Alternatively, the touch panel and the display panel may be integrally formed.

Referring to FIG. 4, the display panel 100 may include a base substrate 110, a display layer 120 disposed on the base substrate 110, an encapsulation layer 130 disposed on the display layer 120 and a touch layer 140 disposed on the encapsulation layer 130. The display layer 120 may include a light emitting element. The touch layer 140 may include the touch sensor TS.

Referring to FIG. 5, the display panel 100 may include a base substrate 110, a display layer 120 disposed on the base substrate 110, a touch layer 140 disposed on the display layer 120 and an encapsulation layer 130 disposed on the touch layer 140. The display layer 120 may include a light emitting element. The touch layer 140 may include the touch sensor TS.

The touch driver 700 may apply a touch signal to the touch sensor TS. The touch driver 700 may sense a touch sensing voltage of the touch sensor TS. For example, the touch sensing voltage may be called as a touch sensing signal. In the present embodiment, the touch driver 700 may receive the touch sensing signal from the touch sensor TS. The touch driver 700 may drive the touch sensor TS. For example, the touch driver 700 may perform a touch sensing operation on the touch sensor TS. For example, the touch driver 700 may perform a touch driving operation on the touch sensor TS. In the present embodiment, the driving controller 200 may output a touch enable signal TEN to the touch driver 700. The touch driver 700 may perform the touch sensing operation in response to the touch enable signal TEN. The touch driver 700 may be turned on in response to the touch enable signal TEN. The touch driver 700 may output a signal to the driving controller 200. In the present embodiment, the driving controller 200 may control the driving of the display panel 100 and the operation of the touch driver 700.

In the present embodiment, the touch sensing operation may include a touch signal applying operation and a touch sensing signal receiving operation. In an embodiment, the touch sensing operation may further include a touch sensing signal calculating operation. The touch signal applying operation may refer to an operation of applying the touch signal to the touch sensor TS. The touch sensing signal receiving operation may refer to an operation of receiving the touch sensing signal from the touch sensor TS. In an embodiment, the touch sensing signal calculating operation, the touch driving operation may refer to an operation of calculating the touch sensing signal.

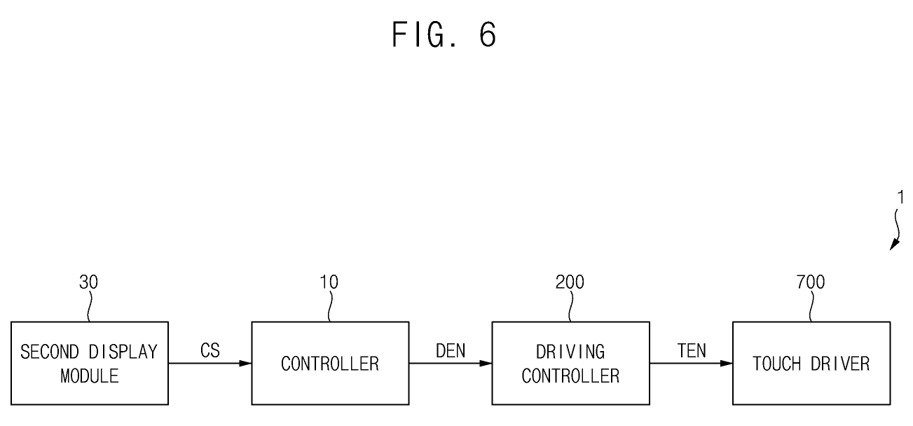

FIG. 6 is a block diagram illustrating an example of a second display module 30, a controller 10, a driving controller 200 and a touch driver 700 included in an electronic device 1 of FIG. 1.

Referring to FIGS. 1 through 6, the second display module 30 may output the connection signal CS based on the connection with the controller 10.

For example, when the second display module 30 is connected to the controller 10, the controller 10 may output the connection signal CS having an active level. The second display module 30 may output the display enable signal DEN having an inactive level to the driving controller 200 in response to the connection signal CS having an active level. The driving controller 200 may output the touch enable signal TEN having an inactive level in response to the display enable signal DEN having an inactive level. The driving controller 200 may stop the display panel driving in response to the display enable signal DEN having an inactive level. For example, after the driving controller 200 outputs the touch enable signal TEN having an inactive level, the driving controller 200 may stop the display panel driving. For example, after the driving controller 200 outputs the touch enable signal TEN having an inactive level, the driving controller 200 may be turned off. The touch driver 700 may stop the touch sensing operation in response to the touch enable signal TEN having an inactive level. For example, the touch driver 700 may be turned off in response to the touch enable signal TEN having an inactive level.

For example, when the connection between the second display module 30 and the controller 10 is interrupted, the connection signal CS having an inactive level may be outputted. The controller 10 may output the display enable signal DEN having an active level to the driving controller 200 in response to the connection signal CS having the inactive level. The driving controller 200 may output the touch enable signal TEN having an active level in response to the display enable signal DEN having an active level. The driving controller 200 may perform the display panel driving in response to the display enable signal DEN having an active level. For example, the driving controller 200 may start the display panel driving in response to the display enable signal DEN having the active level. For example, after the driving controller 200 starts the display panel driving, the driving controller 200 may output the touch enable signal TEN having an active level. The touch driver 700 may perform the touch sensing operation in response to the touch enable signal TEN having the active level. For example, the touch driver 700 may start the touch sensing operation in response to the touch enable signal TEN having the active level.

In the present embodiment, based on the connection between the second display module 30 and the controller 10, the driving controller 200 may output the touch enable signal TEN to the touch driver 700. Since the driving controller 200 may output the touch enable signal TEN to the touch driver 700, a reliability of the touch sensing operation and the display panel driving may be improved, compared to a case where the controller 10 outputs the touch enable signal TEN. For example, when the connection between the second display module 30 and the controller 10 is interrupted, the touch sensing operation may be performed after the display panel driving is started. When the display panel driving is started after the touch sensing operation is started, the reliability of the touch sensing operation may be reduced based on the start of the display panel driving. In the present embodiment, since the touch sensing operation may be performed after the display panel driving is initiated, any reduction in reliability of the touch sensing operation may be avoided. Accordingly, a display quality and a touch quality of the electronic device 1 may be improved.

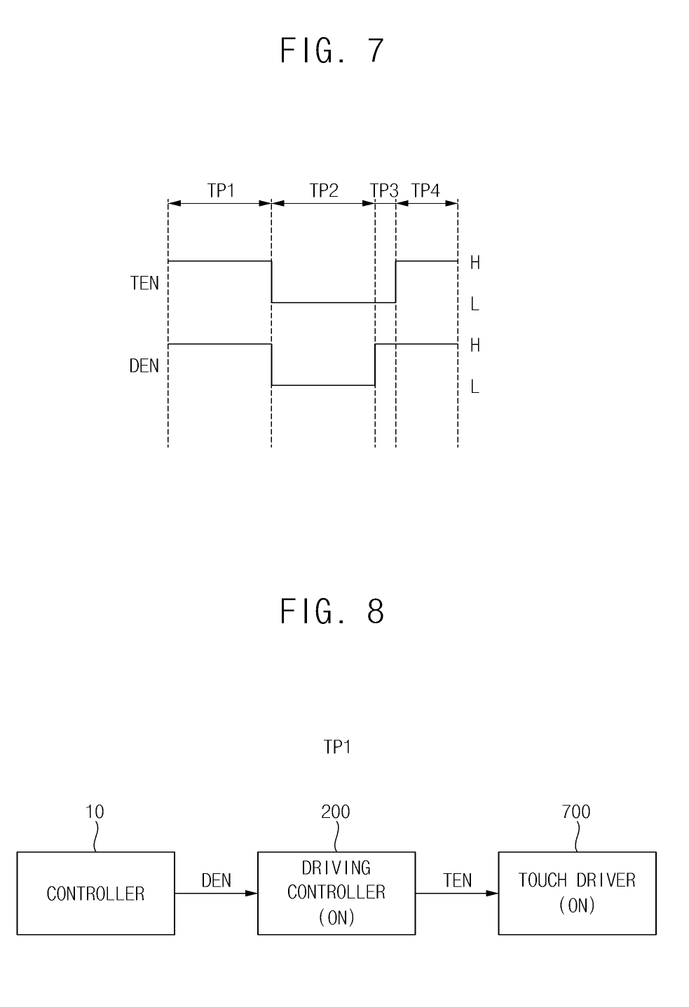

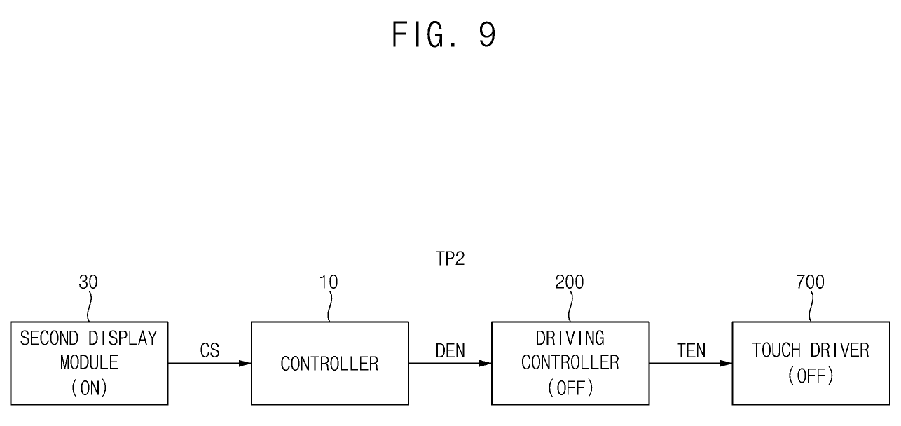

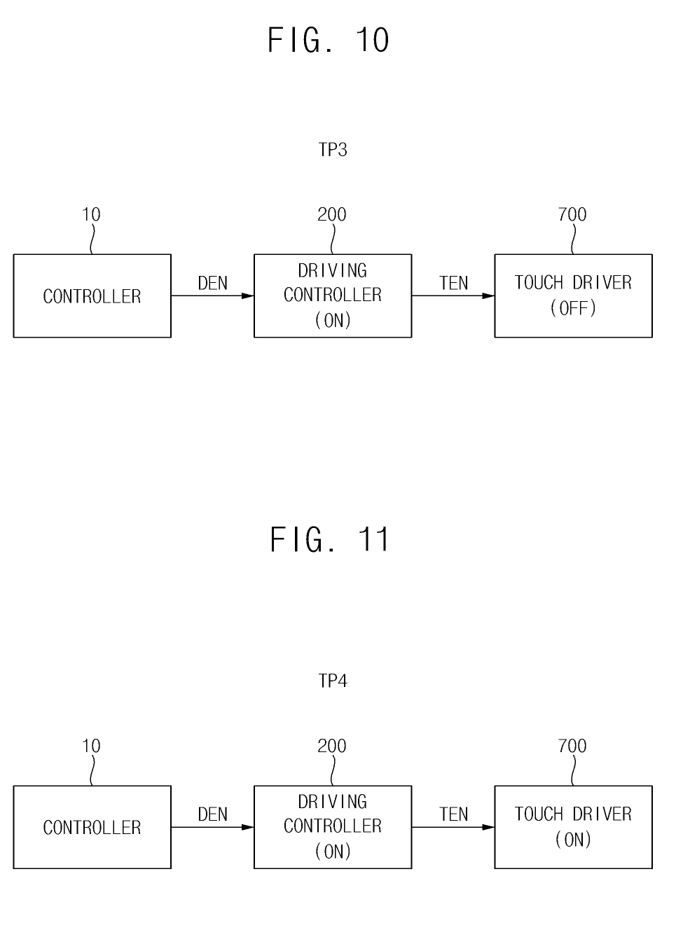

FIG. 7 is a timing diagram illustrating an example of a period in which a first display module 20 of FIG. 2 is driven. FIG. 8 is a block diagram illustrating an operation of an electronic device 1 in a first period TP1 of FIG. 7. FIG. 9 is a block diagram showing an operation of an electronic device 1 in a second period TP2 of FIG. 7. FIG. 10 is a block diagram illustrating an operation of an electronic device 1 in a third period TP3 of FIG. 7. FIG. 11 is a block diagram illustrating an operation of an electronic device 1 in a fourth section TP4 of FIG. 7.

Referring to FIGS. 1 to 11, a period in which the first display module 20 is driven may include the first to fourth periods TP1, TP2, TP3 and TP4.

In the first period TP1, the touch enable signal TEN may have an active level H, and the display enable signal DEN may have an active level H. In the first period TP1, the connection between the controller 10 and the second display module 30 may be interrupted. In the first period TP1, the connection signal CS may have an inactive level.

In the first period TP1, the controller 10 may output the display enable signal DEN having the active level H. In the first period TP1, the driving controller 200 may be turned on in response to the display enable signal DEN having the active level H. In the first period TP1, the driving controller 200 may maintain a turned-on state in response to the display enable signal DEN having the active level H. In the first period TP1, the driving controller 200 may output the touch enable signal TEN having the active level H to the touch driver 700. In the first period TP1, the touch driver 700 may be turned on in response to the touch enable signal TEN having the active level H. In the first period TP1, the touch driver 700 may maintain a turn on state in response to the touch enable signal TEN having the active level H.

In the first period TP1, the controller 10 may drive the first display module 20. In the first period TP1, the first display module 20 may perform the display panel driving and the touch sensing operation.

In the second period TP2, the touch enable signal TEN may have an inactive level L, and the display enable signal DEN may have the inactive level L. In the second period TP2, the controller 10 and the second display module 30 may be connected. In the second period TP2, the second display module 30 may be turned on. In the second period TP2, the connection signal CS may have an active level.

In the second period TP2, the controller 10 may output the display enable signal DEN having the inactive level L to the first display module 20. In the second period TP2, the driving controller 200 may be turned off in response to the display enable signal DEN having the inactive level L. In the second period TP2, the driving controller 200 may output the touch enable signal TEN having the inactive level L to the touch driver 700. In the second period TP2, the touch driver 700 may be turned off in response to the touch enable signal TEN having the inactive level L.

In the second period TP2, the controller 10 may drive the second display module 30. In the second period TP2, the second display module 30 may display an image based on the second input image data IMG2. In the second period TP2, the controller 10 may stop driving the first display module 20. In the second period TP2, the first display module 20 may not perform the display panel driving and the touch sensing operation.

In the third period TP3, the touch enable signal TEN may have the inactive level L, and the display enable signal DEN may have the active level H. In the third period TP3, the controller 10 and the second display module 30 may be disconnected, causing the connection signal CS to have an inactive level.

In the third period TP3, the controller 10 may output the display enable signal DEN having the active level H. In the third period TP3, the driving controller 200 may be turned on in response to the display enable signal DEN having the active level H. In the third period TP3, the driving controller 200 may output the touch enable signal TEN having the inactive level L to the touch driver 700. In the third period TP3, the touch driver 700 may be turned off in response to the touch enable signal TEN having the inactive level (L). In the third period TP3, the touch driver 700 may maintain a turned-off state in response to the touch enable signal TEN having the inactive level L.

In the third period TP3, the controller 10 may drive the first display module 20. In the third period TP3, the first display module 20 may perform the display panel driving. In the third period TP3, the touch enable signal TEN may have an inactive level, so the first display module 20 may not perform the touch sensing operation.

In the fourth period TP4, the touch enable signal TEN may have the active level H, and the display enable signal DEN may have the active level H. In the fourth period TP4, the controller 10 and the second display module 30 may be disconnected. In the fourth period TP4, the connection signal CS may have an inactive level.

In the fourth period TP4, the controller 10 may output the display enable signal DEN having the active level H. In the fourth period TP4, the driving controller 200 may maintain a turned-on state in response to the display enable signal DEN having the active level H. In the fourth period TP4, the driving controller 200 may output the touch enable signal TEN having the active level H to the touch driver 700. In the fourth period TP4, the touch driver 700 may be turned on in response to the touch enable signal TEN having the active level H.

In the fourth period TP4, the controller 10 may drive the first display module 20. In the fourth period TP4, the first display module 20 may perform the display panel driving and the touch sensing operation.

In the present embodiment, based on the connection between the second display module 30 and the controller 10, the driving controller 200 may output the touch enable signal TEN to the touch driver 700. Since the driving controller 200 may output the touch enable signal TEN to the touch driver 700, the reliability of the touch sensing operation and the display panel driving may be improved, compared to a case where the controller 10 outputs the touch enable signal TEN. For example, when the connection between the second display module 30 and the controller 10 is interrupted, the touch sensing operation may be performed after the display panel driving is started. When the display panel driving is started after the touch sensing operation is started, the reliability of the touch sensing operation may deteriorate based on the start of the display panel driving. In the present embodiment, since the touch sensing operation may be performed after the display panel drive is initiated, a reliability of the touch sensing operation may be improved. Accordingly, a display quality and a touch quality of the electronic device 1 may be improved.

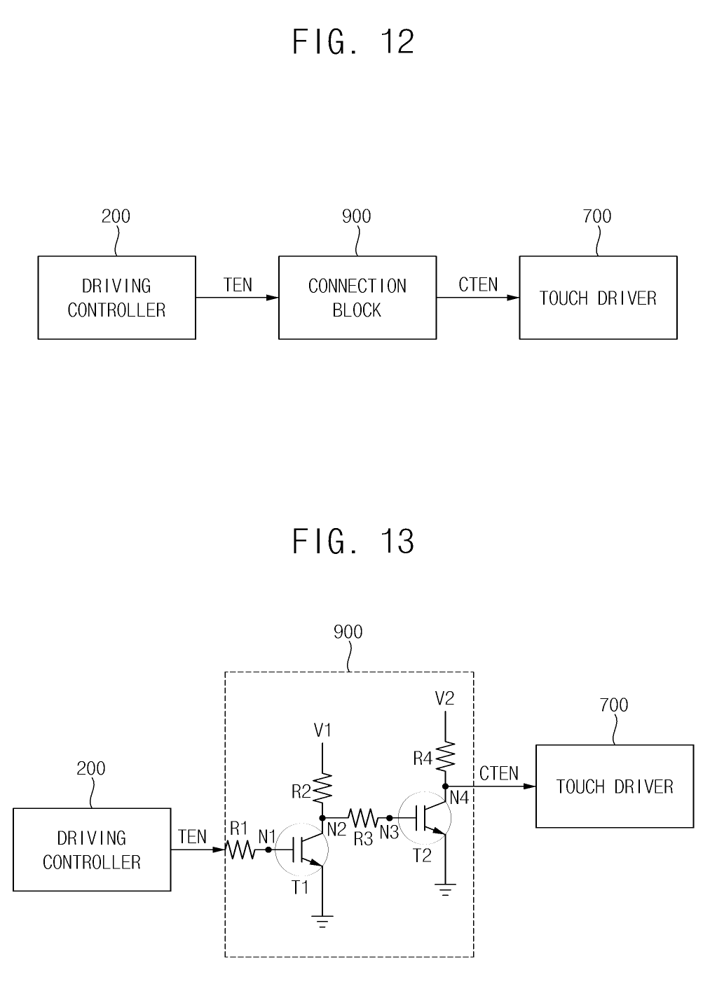

FIG. 12 is a block diagram illustrating an example of a first display module 20 included in an electronic device 1 of FIG. 1.

Referring to FIGS. 1 to 12, the first display module 20 may further include a connection block 900. The connection block 900 may be connected between the driving controller 200 and the touch driver 700.

The connection block 900 may receive the touch enable signal TEN from the driving controller 200. The connection block 900 may output a converted touch enable signal CTEN to the touch driver 700. The converted touch enable signal CTEN may be a delayed signal of the touch enable signal TEN. In an embodiment, a voltage level corresponding to the active level H of the converted touch enable signal CTEN may be different from a voltage level corresponding to the active level H of the touch enable signal TEN. In an embodiment, the voltage level corresponding to the active level H of the converted touch enable signal CTEN may be higher than the voltage level corresponding to the active level H of the touch enable signal TEN. In an embodiment, the connection block 900 may be a buffer block. In an embodiment, the connection block 900 may be a level shifter. Accordingly, when the driving voltage of the driving controller 200 and the driving voltage of the touch driver 700 are different, the touch driver 700 may operate stably.

FIG. 13 is a circuit diagram illustrating an example of a connection block 900 included in an electronic device 1 of FIG. 12.

Referring to FIGS. 1 to 13, the connection block 900 may include a first resistor R1, a second resistor R2, a third resistor R3, a fourth resistor R4, a first switching element T1 and a second switching element T2.

The first resistor R1 may include a first terminal receiving the touch enable signal TEN and a second terminal connected to a first node N1. The second resistor R2 may include a first terminal receiving a first voltage V1 and a second terminal connected to a second node N2. The third resistor R3 may include a first terminal connected to the second node N2 and a second terminal connected to a third node N3. The fourth resistor R4 may include a first terminal receiving a second voltage V2 and a second terminal connected to a fourth node N4. The first voltage V1 may be different from the second voltage V2. For example, the second voltage V2 may be higher than the first voltage V1.

The first switching element T1 may include a control electrode connected to the first node N1, a first electrode connected to the second node N2 and a second electrode receiving a ground voltage. The second switching element T2 may include a control electrode connected to the third node N3, a first electrode connected to the fourth node N4 and a second electrode receiving the ground voltage. The first switching element T1 and the second switching element T2 may be transistors. However, the present inventive concept is not limited to any particular type of transistor.

The converted touch enable signal CTEN may be outputted from the fourth node N4. For example, the fourth node N4 may output the converted touch enable signal CTEN.

When the touch enable signal TEN has the active level H, the first switching element T1 may be turned on. Since the first switching element T1 may be turned on, the ground voltage may be applied to the second node N2. Since the ground voltage may be applied to the second node N2, the second switching element T2 may be turned off. Since the second switching element T2 may be turned off, the second voltage V2 may be applied to the fourth node N4. Accordingly, the active level H of the converted touch enable signal CTEN may have the second voltage V2.

When the touch enable signal TEN has the inactive level L, the first switching element T1 may be turned off. Since the first switching element T1 may be turned off, the first voltage V1 may be applied to the second node N2. Since the first voltage V1 may be applied to the second node N2, the second switching element T2 may be turned on. Since the second switching element T2 may be turned on, the converted touch enable signal CTEN may have the inactive level L.

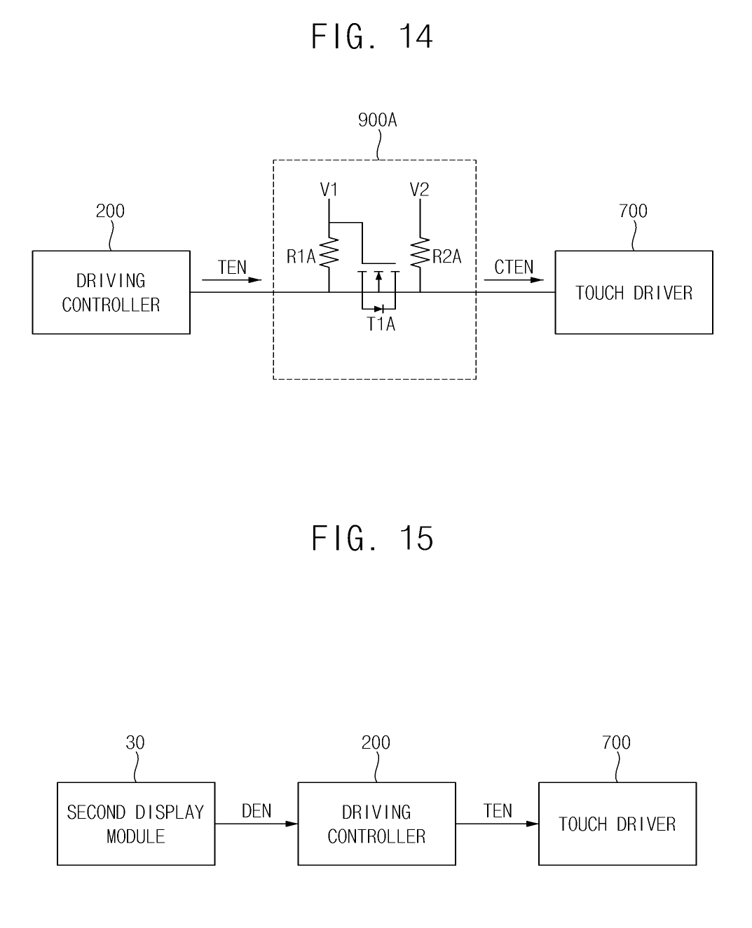

FIG. 14 is a circuit diagram illustrating an example of a connection block 900 included in an electronic device 1 of FIG. 12.

Referring to FIGS. 1 to 12 and 14, a connection block 900A may include a first resistor R1A, a second resistor R2A and a first switching element T1A.

The first resistor R1A may include a first terminal receiving the first voltage V1 and a second terminal receiving the touch enable signal TEN. The second resistor R2A may include a first terminal receiving the second voltage V2 and a second terminal for outputting the converted touch enable signal CTEN. The first switching element T1A may include a control electrode receiving the first voltage V1, a first electrode receiving the touch enable signal TEN and a second electrode for outputting the converted touch enable signal CTEN. The first electrode of the first switching element T1A may be connected to the second terminal of the first resistor R1A. The second electrode of the first switching element T1A may be connected to the second terminal of the second resistor R2A. The first switching element T1A may be a transistor. However, the present inventive concepts is not limited to any particular type of transistor.

When the touch enable signal TEN has the active level H, the first switching element T1A may be turned off. Since the first switching element T1A may be turned off, the active level H of the converted touch enable signal CTEN may have the second voltage V2.

When the touch enable signal TEN has the inactive level L, the first switching element T1A may be turned on. Accordingly, the converted touch enable signal CTEN may have the inactive level L.

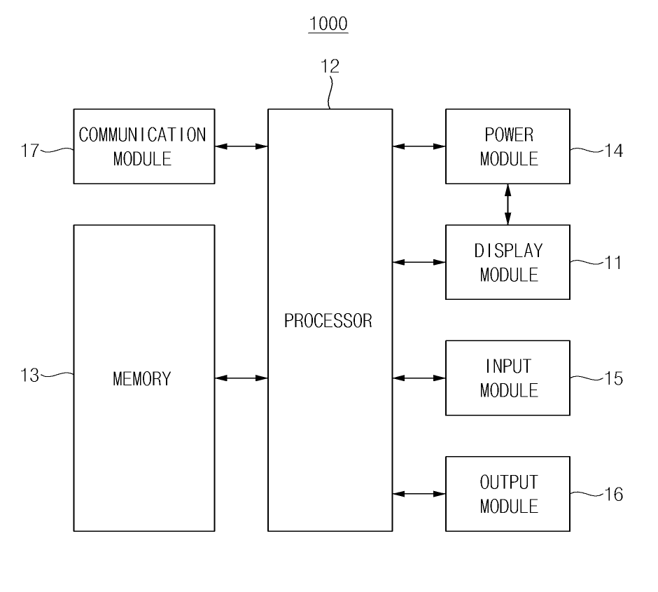

FIG. 15 is a block diagram illustrating an example of a second display module 30, a driving controller 200 and a touch driver 700 included in an electronic device 1 of FIG. 1.

The driving controller 200 of FIG. 15 is substantially same as the electronic device 1 of the previous embodiment, except that the driving controller 200 receives the display enable signal DEN from the second display module 3, so that the same reference numerals will be used and any repetitive explanation concerning the above elements will be omitted.

In the present embodiment, when the second display module 30 and the controller 10 are connected, the second display module 30 may output the display enable signal DEN having an inactive level to the controller 10. Additionally, when a connection between the second display module 30 and the controller 10 is interrupted, the second display module 30 may output the display enable signal DEN having an active level to the controller 10.

In the present embodiment, based on the connection between the second display module 30 and the controller 10, the driving controller 200 may output the touch enable signal TEN to the touch driver 700. Since the driving controller 200 may output the touch enable signal TEN to the touch driver 700, a reliability of the touch sensing operation and the display panel driving may be improved compared to a case where the controller 10 outputs the touch enable signal TEN. For example, when the connection between the second display module 30 and the controller 10 is interrupted, the touch sensing operation may be performed after the display panel driving is started. As mentioned above, if the display panel driving starts after the touch sensing operation is started, the reliability of the touch sensing operation may be deteriorated based on the start of the display panel driving. In the present embodiment, since the touch sensing operation may be performed after the display panel drive is initiated, any such compromise of reliability of the touch sensing operation may be avoided. Accordingly, a display quality and a touch quality of the electronic device 1 may be improved.

Additionally, in the present embodiment, the driving controller 200 may receive the display enable signal DEN from the second display module 30 rather than the controller 10. Accordingly, a reliability of the display enable signal DEN may be improved.

FIG. 16 is a block diagram illustrating an electronic device 10 according to embodiments of the present inventive concept.

Referring to FIG. 16, an electronic device 10 according to an embodiment may include a display module 11, a processor 12, a memory 13 and a power module 14. The electronic device 1000 may correspond to the electronic device 1 of FIG. 1.

The processor 12 may include at least one of a central processing unit (CPU), an application processor (AP), a graphic processing unit (GPU), a communication processor (CP), an image signal processor (ISP), and a controller. The processor 12 may output the first input control signal ICONT1 and the second input control signal ICONT2. The processor may correspond to the controller 10 of FIG. 1.

The memory 13 may store data information necessary for the operation of the processor 12 or the display module 11. When the processor 12 executes an application stored in the memory 13, an image data signal and/or an input control signal is transmitted to the display module 11, and the display module 11 may process the received signal and output image information through a display screen.

The power module 14 may include a power supply module, such as a power adapter or a battery device, and a power conversion module which converts power supplied by the power supply module to generate power required for the operation of the electronic device 10.

The electronic device 10 may further include an input module 15, a non-image output module 16 and/or a communication module 17.

The input module 15 may provide input information to the processor 12 and/or the display module 11. The input module 15 may include various sensor modules as well as physical buttons, a keyboard, and a microphone. Examples of the sensor modules may include a touch sensor, a pressure sensor, a distance sensor, a position sensor, a digitizer, a motion recognition sensor, a camera sensor, a light receiving sensor, a photoelectric conversion sensor, a temperature sensor, and a biosensor such as a blood pressure sensor, a blood sugar sensor, an electrocardiogram sensor, and a heart rate sensor.

The non-image output module 16 may receive information other than images from the processor 12 and provide the information to the user. Examples of the non-image output module 16 may include an audio module, a haptic module, a light-emitting module, etc., and may include other functional modules unique to electronic devices (e.g., a cooling module of a refrigerator, etc.).

The communication module 17 may be a module that is responsible for transmitting and receiving information between the electronic device 10 and an external device, and may include a receiving unit and a transmitting unit. The communication module 17 may include various wireless communication modules such as a mobile communication module, a Wi-Fi module, a Bluetooth module, or various wired communication modules.

At least one of the components of the electronic device 10 described above may be included in the display device according to the embodiments described above. Additionally, some of the individual modules functionally included in one module may be included in the display device, and other may be provided separately from the display device. For example, the display device may include the display module 11, and the processor 12, the memory 13, and the power module 14 may be provided in the form of other devices within the electronic device 10 other than the display device.

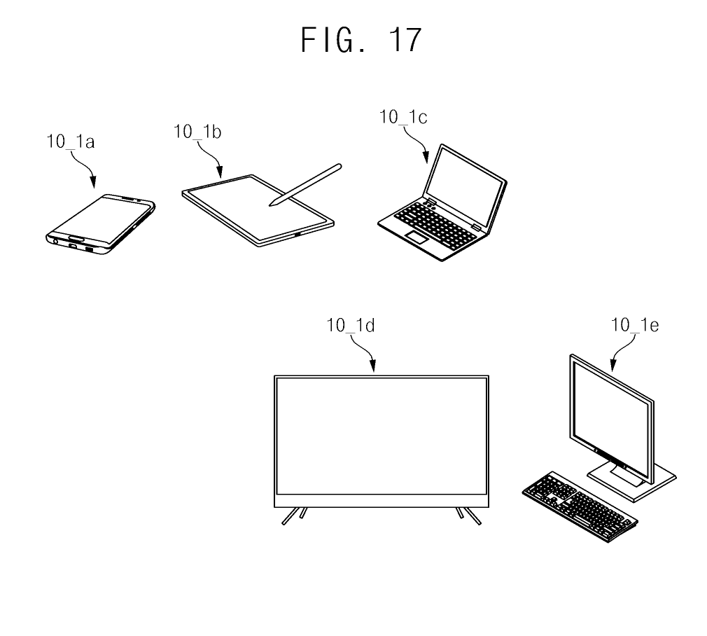

FIGS. 17 to 19 are schematic diagrams illustrating an electronic device according to embodiments.

Referring to FIG. 17, a smartphone 10_1a, a tablet PC 10_1b, a laptop 10_1c, a TV 10_1d, and a desk monitor 10_1e are examples of electronic devices.

The smartphone 10_1a may include an input module such as a touch sensor and a communication module in addition to the display module 11. The smartphone 10_1a may process information received through the communication module or other input modules and display the information through the display module of the display device.

In the case of tablet PC 10_1b, laptop 10_1c, TV 10_1d, and desk monitor 10_1e, may include a display module and an input module similar to the smartphone 10_1a, and in some cases, may further include a communication module.

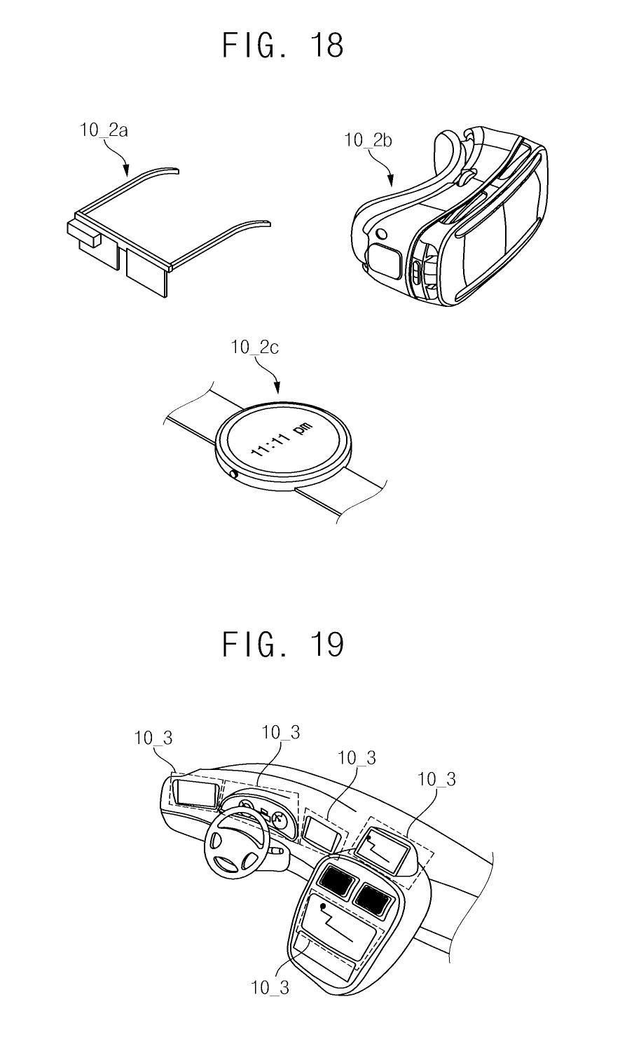

Referring to FIG. 18, an electronic device including a display module may be applied to a wearable electronic device. The wearable electronic device may be a smart glasses 10_2a, a head mounted display 10_2b, a smart watch 10_2c, etc.

The smart glasses 10_2a and head mounted displays 10_2b may include a display module which emits a display image and a reflector which reflects the emitted display image and provides it to the user's eyes, thereby providing a virtual reality or augmented reality screen to the user.

The smartwatch 10_2c may include a biometric sensor as an input device and may provide biometric information recognized by the biometric sensor to the user through a display module.

Referring to FIG. 19, an electronic device including a display module may be applied to a vehicle. For example, the electronic device 10_3 may be applied to a dashboard, center fascia, etc. of a vehicle, or may be applied to a CID (Center Information Display) placed on a dashboard of a vehicle or a room mirror display replacing a side mirror.

Although not illustrated, electronic devices to which the display device according to the embodiments is applied may include not only devices that mainly display screens, such as billboards, electronic boards, and game consoles, but also various home appliances that display information through display modules, such as refrigerators, washing machines, dryers, air conditioners, and robot vacuum cleaners. Additionally, when the display module has a function of transmitting light, it may be applied to electronic devices, such as smart windows or transparent display devices that display a background and a display image together. The type of electronic device according to the embodiment is not limited by the examples, and application to other various electronic devices that are not illustrated may also be possible.

The display device according to the embodiments may be applied to a display device included in a computer, a notebook, a mobile phone, a smart phone, a smart pad, a PMP, a PDA, an MP3 player, or the like.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

What is claimed is:

1. An electronic device comprising:
a first display module configured to display an image based on first input image data in response to a display enable signal;
a second display module configured to display an image based on second input image data; and
a controller configured to output the display enable signal, the first input image data and the second input image data,
wherein the first display module includes:
a display panel having pixels that display the image based on a data signal;
a touch panel having touch sensors that perform a touch sensing operation;
a driving controller configured to output the data signal based on the first input image data in response to the display enable signal; and
a touch driver configured to drive the touch panel in response to a touch enable signal,
wherein the controller outputs the display enable signal based on a connection between the controller and the second display module, and
wherein the driving controller outputs the touch enable signal in response to the display enable signal.

2. The electronic device of claim 1, wherein a connection signal has an active level in response to the second display module and the controller being connected,
wherein the driving controller is turned off in response to the connection signal having an active level, , and
wherein the touch driver is turned off after the driving controller is turned off.

3. The electronic device of claim 2, wherein the connection signal has an active level and the controller outputs the display enable signal having an inactive level in response to the second display module and the controller being connected,
wherein the driving controller outputs the touch enable signal having an inactive level in response to the display enable signal having an inactive level,
wherein the driving controller is turned off in response to the display enable signal having an inactive level, and
wherein the touch driver is turned off in response to the touch enable signal having an inactive level.

4. The electronic device of claim 1, wherein a connection signal has an inactive level in response to the second display module and the controller being disconnected,
wherein the driving controller is turned on in response to the connection signal having an inactive level, and
wherein the touch driver is turned on after the driving controller is turned on.

5. The electronic device of claim 4, wherein the connection signal has an inactive level and the controller outputs the display enable signal having an active level in response to the second display module and the controller being disconnected,
wherein the driving controller outputs the touch enable signal having an active level in response to the display enable signal having an active level,
wherein the driving controller is turned on in response to the display enable signal having an active level, and
wherein the touch driver is turned on in response to the touch enable signal having an active level.

6. The electronic device of claim 1, wherein a period in which the first display module is driven includes a first period, a second period, and a third period,
wherein in the first period, the touch enable signal has an inactive level, and the display enable signal has an inactive level,
wherein in the second period, the touch enable signal has an inactive level, and the display enable signal has an active level, and
wherein in the third period, the touch enable signal has an active level, and the display enable signal has an active level.

7. The electronic device of claim 6, wherein in the second period, the driving controller is turned on, and the touch driver maintains a turned off state.

8. The electronic device of claim 7, wherein in the third period, the driving controller maintains a turned on state, and the touch driver is turned on.

9. The electronic device of claim 1, wherein the first display module further includes a connection block which connects the driving controller and the touch driver, and
wherein the connection block outputs a converted touch enable signal in which the touch enable signal is delayed to the touch driver.

10. The electronic device of claim 9, wherein an active voltage level of the converted touch enable signal is different from an active voltage level of the touch enable signal.

11. The electronic device of claim 10, wherein the active voltage level of the converted touch enable signal is higher than the active voltage level of the touch enable signal.

12. The electronic device of claim 10, wherein the connection block includes:
a first resistor including a first terminal receiving the touch enable signal and a second terminal connected to a first node;
a first switching element including a control electrode connected to the first node, a first electrode connected to a second node and a second electrode receiving a ground voltage;
a second resistor including a first terminal receiving a first voltage and a second terminal connected to the second node;
a third resistor including a first terminal connected to the second node and a second terminal connected to a third node;
a second switching element including a control electrode connected to the third node, a first electrode connected to a fourth node, and a second electrode receiving the ground voltage; and
a fourth resistor including a first terminal receiving a second voltage different from the first voltage and a second terminal connected to the fourth node, and
wherein the fourth node outputs the converted touch enable signal.

13. The electronic device of claim 10, wherein the connection block includes:
a first switching element including a control electrode receiving a first voltage, a first electrode receiving the touch enable signal and a second electrode receiving the converted touch enable signal;
a first resistor including a first terminal receiving the first voltage and a second terminal connected to the first electrode of the first switching element; and
a second resistor including a first terminal receiving a second voltage different from the first voltage and a second terminal connected to the second electrode of the first switching element.

14. An electronic device comprising:
a first display module configured to display an image based on first input image data in response to a display enable signal; and
a controller configured to output the display enable signal and the first input image data,
wherein the controller controls the first display module in response to a connection signal,
wherein the first display module stops operating in response to the connection signal having an active level, and
wherein in response to the connection signal changing from an active level to an inactive level, the first display module starts a touch sensing operation after the display panel driving is started.

15. The electronic device of claim 14, wherein a period in which the first display module is driven includes a first period, a second period, and a third period,
wherein in the first period, an operation of the first display module is stopped,
wherein in the second period, the display panel driving is performed, and the touch sensing operation maintains stopped state, and
wherein in the third period, the display panel driving is performed, and the touch sensing operation is performed.

16. The electronic device of claim 14, wherein the first display module includes:
a driving controller configured to control the display panel driving in response to the display enable signal; and
a touch driver configured to perform the touch sensing operation in response to a touch enable signal, and
wherein the driving controller outputs the touch enable signal in response to the display enable signal.

17. The electronic device of claim 16, wherein the first display module further includes a connection block connecting the driving controller and the touch driver, and
wherein the connection block outputs a converted touch enable signal which delays the touch enable signal reaching the touch driver.

18. The electronic device of claim 17, wherein an active voltage level of the converted touch enable signal is different from an active voltage level of the touch enable signal.

19. A display device comprising:
a display panel configured to display an image based on a data signal;
a touch panel configured to perform a touch sensing operation;
a driving controller configured to output the data signal based on a first input image data in response to a display enable signal; and
a touch driver configured to drive the touch panel in response to a touch enable signal,
wherein the driving controller receives the display enable signal based on a connection signal indicating a connection to a display module, and
wherein the driving controller outputs the touch enable signal in response to the display enable signal.

20. The display device of claim 19, further including a connection block connecting the driving controller and the touch driver,
wherein the connection block outputs a converted touch enable signal which delays the touch enable signal reaching the touch driver.
